(19) United States
(12) Patent Application Publication
(10) Pub. No.: US 2016/0037195 A1
(43) Pub. Date: Feb. 4, 2016

(54) DISPLAY APPARATUS AND CONTROLLING METHOD FOR PROVIDING SERVICES BASED ON USER'S INTENT

(71) Applicant: SAMSUNG ELECTRONICS CO., LTD., Suwon-si (KR)

(72) Inventors: Seung-min SHIN, Bucheon-si (KR); Seung-won KIM, Gwangju-si (KR); Yong-wook SHIN, Osan-si (KR); Yong-hoon LEE, Yongin-si (KR); Dong-hyun CHOI, Suwon-si (KR)

(73) Assignee: SAMSUNG ELECTRONICS CO., LTD., Suwon-si (KR)

(21) Appl. No.: 14/619,191

(22) Filed: Feb. 11, 2015

(30) Foreign Application Priority Data
Jul. 29, 2014 (KR) 10-2014-0096730

(51) Int. Cl. H04N 21/25; H04N 21/442; H04N 21/45; H04N 21/466

(52) U.S. Cl. CPC H04N 21/252; H04N 21/4668; H04N 21/44222; H04N 21/4532

(57) ABSTRACT

A display apparatus is provided. The display apparatus may include a display configured to display a content, a detector configured to acquire feature information of a user in the vicinity of the display apparatus and surrounding environment information and a controller configured to acquire state information of the display apparatus, determine a control command corresponding to an intent of the user based on at least one of feature information of the acquired user, surrounding environment information and state information of the display apparatus, and change at least one of the content and a setting of the display apparatus based on the control command.

### CROSS-REFERENCE TO RELATED APPLICATION(S)

This application claims priority from Korean Patent Application No. 10-2014-0096730, filed on Jul. 29, 2014, in the Korean Intellectual Property Office, the disclosure of which is incorporated herein by reference in its entirety.

### BACKGROUND

1. Field

Methods and apparatuses consistent with the exemplary embodiments relate to a display apparatus and a method for controlling a display apparatus, and more particularly, to a display apparatus which understands a user's intent and provides a service and a method for controlling a display apparatus thereof.

2. Description of the Related Art

With the development of electronic technologies, various kinds of electronic apparatuses have been developed and distributed, and the electronic apparatuses are equipped with various functions in accordance with the requirements of users. Specifically, various display apparatuses, for example, televisions (TVs) receive various contents from various sources and output the received contents. For example, the various display apparatuses are connected, not only to a broadcast content provider, but also to the Internet, and is provided with content from various servers, or communicates with various external apparatuses, and is provided with content from those external apparatuses. Additionally, various screen or volume setting values may be changed when the user wishes to view content in an optimal environment according to a kind of a content being displayed or the surrounding environment.

Accordingly, a user of a display apparatus may directly input a specific intent, such as changing a channel or controlling a volume or sound or the resolution of the display apparatus and the like, through an input apparatus such as a remote controller, and may view a specific content among various contents in an environment.

However, searching through each of the contents and changing a setting of a display apparatus may be inconvenient for the user. Accordingly, a technology for providing a service which changes a content or a setting of a display apparatus based on an understanding of the user's intent beforehand even if the user of the display apparatus does not expressly convey an intent, is required.

Further, a system for identifying a user using a camera and recommending content to the identified user according to a predefined recommendation pattern has been developed. However, this system may have an inaccurate recognition rate because only image information or voice information received through a camera is used, and therefore an incorrect recommendation is made to the user.

### SUMMARY

The exemplary embodiments have been made to address at least the above problems and an aspect of the exemplary embodiments provides a display apparatus and a method for understanding a user's intent even if the user's intent is not explicitly expressed through an inputted method, and providing a service corresponding to the user's intent.

A display apparatus according to an exemplary embodiment may include a display configured to display a content, a detector configured to acquire feature information of a user who is in the vicinity of the display apparatus and surrounding environment information, and a controller configured to acquire state information of the display apparatus, determine a control command corresponding to an intent of the user based on at least one among feature information of the acquired user, surrounding environment information and state information of the display apparatus, and change at least one of the content and a setting of the display apparatus based on the control command.

According to another aspect of the exemplary embodiment, a storage is configured to store user profile information including a user's use history information and preference information may be further included, and the controller may identify the user based on the user's feature information acquired through the detector, analyze at least one among feature information of the acquired user, surrounding environment information and state information of the display apparatus based on profile information of the identified user, and determine a control command corresponding to the intent of the user.

According to another aspect of the exemplary embodiment, the controller, in response to the identified user not being a pre-registered user, registers the identified user, determines the user's use history information and preference information based on at least one among the user's feature information, surrounding environment information and state information of the display apparatus acquired during a predetermined time, and stores the determined information as profile information of the registered user.

According to the exemplary embodiment, the state information of the display apparatus includes setting information of the display apparatus, and the controller determines preference setting information corresponding to the displayed content based on profile information of the identified user while the content is displayed, compares setting information of the display apparatus and the preference setting information and changes a setting of the display apparatus.

According to another aspect of the exemplary embodiment, the state information of the display apparatus includes information regarding the displayed content, and the controller determines preference content information corresponding to the acquired surrounding environment information based on profile information of the identified user while the content is displayed, compares information regarding the displayed content and the preference content information, and changes the content.

According to another aspect of the exemplary embodiment, the controller determines whether a channel is zapped by the user based on profile information of the identified user while the content is displayed, and if it is determined that the user is watching a specific channel after channel zapping, the controller increases a preference regarding the specific channel and stores profile information of the user.

According to the exemplary embodiment, the surrounding environment information includes information regarding a noise in the vicinity of the display apparatus, and the controller, in response to a loudness of a noise of a specific frequency band being detected among the surrounding noises acquired through a detector while the content is displayed being greater than a predetermined value, increases and outputs a loudness of a volume of the display apparatus at the specific frequency band.

According to the exemplary embodiment, the controller, in response to a plurality of users being recognized through the detector, identifies each user based on specific information of each user, combines profile information of each of the identified users, and determines a control command corresponding to a common intent of each of the plurality of users.

According to the exemplary embodiment, the controller, in response to the user being identified, determines information regarding at least one of a preference application and a preference content of the user based on profile information of the identified user, and pre-loads at least one of the determined preference application and preference content.

According to another aspect of the exemplary embodiments, if it is determined that the viewing of the displayed content is ended within a predetermined time from a current time, the controller determines preference content information of the user based on profile information of the identified user, and recommends content based on the determined preference content information.

According to an exemplary embodiment, the controller may determine information regarding a preferred character or entertainer of the user based on profile information of the identified user, and recommend content based on the determined preferred character or entertainer.

According to the exemplary embodiment, if it is determined that the user is not watching the displayed content, the controller decreases a luminance of the display.

According to an exemplary embodiment, a method of controlling a display apparatus includes displaying a content, acquiring at least one among feature information of a user in the vicinity of the display apparatus, surrounding environment information and state information of the display apparatus, determining a control command corresponding to the user's intent based on the acquired information, and changing at least one of the content and a setting of the display apparatus based on the control command.

According to another aspect of the exemplary embodiments, the display apparatus includes a storage configured to store user profile information including a user's use history information and preference information, and determining the control command includes identifying the user based on specific information of the acquired user and analyzing at least one among feature information of the acquired user, surrounding environment information and state information of the display apparatus based on profile information of the identified user and determining a control command corresponding to the user's intent.

According to another aspect of the exemplary embodiments, the method may further include determining whether the identified user is a pre-registered user, in response to the identified user not being a pre-registered user as a result of the determining, registering the identified user, determining the registered user's use history information and preference information based on at least one among feature information of the user acquired during a predetermined period, surrounding environment information and state information of the display apparatus, and storing the determined use history information and preference information as profile information of the registered user.

According to the various exemplary embodiments, a user of the display apparatus may be provided various services corresponding to a user's intent even if the user does not express his/her intent explicitly through an input means.

### BRIEF DESCRIPTION OF THE DRAWINGS

FIG. 1. is a block diagram illustrating a configuration of a display apparatus according to an exemplary embodiment;

FIG. 2 is a detailed block diagram of a display apparatus according to an exemplary embodiment;

FIG. 3 is a detailed view of a controller according to an exemplary embodiment;

FIG. 4 is an exemplary view illustrating a case where a user watches a specific channel after a channel zapping according to an exemplary embodiment;

FIGS. 5A and 5B are exemplary views illustrating cases where a user does not watch a content according to an exemplary embodiment;

FIGS. 6A and 6B are exemplary views illustrating a display apparatus recommending a content according to an exemplary embodiment;

FIG. 7 is a flowchart illustrating a method of controlling a display apparatus according to an exemplary embodiment; and

FIG. 8 is a flowchart illustrating a method of controlling a display apparatus according to another exemplary embodiment.

### DETAILED DESCRIPTION OF EXEMPLARY EMBODIMENTS

Hereinafter, exemplary embodiments will be described in greater detail with reference to the accompanying drawings.

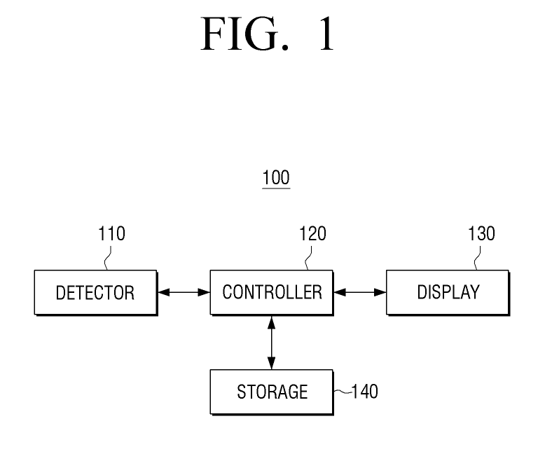

FIG. 1 is a block diagram illustrating a configuration of a display apparatus according to an exemplary embodiment. Herein, the display apparatus may be a smart television (TV), but this is only one of the exemplary embodiments, and the exemplary embodiments may be realized as various display apparatuses such as a smart phone, a tablet personal computer (PC), a notebook PC, a desktop PC, and the like.

According to FIG. 1, the display apparatus 100 may include a detector 110, a controller 120, a display 130, and a storage 140. The detector 110 may detect an external environment of the display apparatus 100. Specifically, the detector 110 may detect feature information of a user in the vicinity of the display apparatus and surrounding environment information. Herein, the feature information of a user may include information regarding the user's face, a position of the user, the number of users, a voice tone, a loudness level of the voice, an existence or nonexistence of the user and the like, and the surrounding environment information may include information regarding an illuminance around the display, noises around the display, a current time and the like. For this, the detector 110 may include an image sensor, a sound sensor and an illuminance sensor and the like to detect feature information of a user around the display apparatus 100 and surrounding environment information.

The display 130 displays various images. Specifically, the display 130 may be controlled by the controller 120 and display an image of various contents acquired from various sources. Also, the display 130 may display a message which recommends changing a content and a setting of the display apparatus 100.

The storage 140 may store various programs and information for driving the display apparatus 100 according to an exemplary embodiment. Especially, the storage 140 may store user profile information including a user's use history of the display apparatus 100 and preference information.

User history information is information regarding a user's usage history of the display apparatus 100, and includes setting change history information representing changes of setting of the display apparatus 100 by the user, watched content history information representing the contents that have been watched through the display apparatus 100 by the user, channel zapping information representing channels zapped by the user, application user history information representing various applications used through the display apparatus 100 by the user.

Preference information is information representing a user's preference regarding a setting of the display apparatus 100, a content, an application, a person and the like. The preference information may include preference information of a specific surrounding environment or information regarding each of a plurality of contents or people. For example, if the surrounding illuminance is dark, the preference information may be content of the genre horror movies.

The controller 120 controls an overall operation of the display apparatus 100. Specifically, the controller 120 may acquire state information of the display apparatus 100. Herein, the state information of the display apparatus 100 includes information regarding a content displayed on the display apparatus 100 and information regarding a setting of the display apparatus 100.

Specifically, the controller 120 may acquire information such as a genre, a type, a title, a broadcasting time, a character and the like regarding a content displayed on a current display unit 130. For example, the controller 120 may acquire information regarding a content through a well-known method such as detecting and analyzing various additional information regarding a content, or using electric program guide information and the like.

The controller 120 may acquire information regarding a screen setting such as a color temperature, brightness, a contrast, a visibility, a resolution, a screen ratio and the like or information regarding a sound setting such as an equalizer, a volume, a wave, a balance and the like. For example, the controller 120 may read information from a memory. The stored information may include information regarding a setting of the display apparatus 100. The controller may then acquire information regarding various settings, but is not limited thereto.

The controller 120 may determine a control command corresponding to an intent of a user using at least one among feature information of a user acquired through the detector 110, surrounding environment information, and state information of the display apparatus 100 which is acquired directly.

Specifically, according to an exemplary embodiment, the controller 120 may identify a user based on specific information of the user acquired through the detector 110, analyze at least one among feature information of the acquired user, surrounding environment information and state information of the display apparatus 100 acquired directly based on profile information of the identified user among profile information of the user stored in the storage 140.

For example, the controller 120 may identify a user using user feature information such as the user's face, the user's voice tone, a loudness level of the user's voice and the like. A specific method of identifying a user using the user's face, the user's voice tone and the like may be well-known methods, but it is not related to the essentials elements of the exemplary embodiments, and thus, specific explanations are omitted.

If a user is identified, the controller 120 may acquire the user's usage history information and preference information through user profile information corresponding to the identified user among the user's profile information stored in the storage 140. The controller 120 may analyze at least one among currently acquired user feature information, surrounding environment information, and state information of the display apparatus 100, and may acquire information regarding various situations in the vicinity of the current display apparatus 100 such as state information of the current display apparatus 100, current surrounding environment information and the like.

Accordingly, the controller 120 may determine a control command corresponding to a user's intent based on information regarding user profile information acquired from the storage 140 and various situations surrounding the described current display apparatus 100. Herein, the controller 120 may combine the profile information of the user and the information regarding various situations surrounding the current display apparatus 100, and determine a control command corresponding to the user's intent using a well-known ontology method or a rule-tree method.

Also, according to another exemplary embodiment, profile information of a user stored in the storage 140 may include usage history information and preference information of a user before a predetermined time based on a current time.

Accordingly, the controller 120 may determine usage history information and preference information of a user using at least one among feature information of the user acquired during a predetermined time, surrounding environment information and state information of the display apparatus, and store a determined user's usage history information and preference information in the storage 140 as profile information of the user. Herein, the predetermined time may be a time from when a power of the display apparatus 100 was last turned on to a current time. However, the predetermined time is not limited thereto, and a specific user may set a time such as 10 minutes, 20 minutes and the like, according to the user's preference, based on a time from an identified time to a current time or based on a current time.

Specifically, the controller 120 may identify a user using feature information of the user acquired through the detector 110, search user profile information stored in the storage 140, determine whether user profile information corresponding to the identified user exists, and determine whether the identified user is a preregistered user.

If it is determined that the identified user is not a preregistered user, the controller 120 may determine various usage history information and preference information regarding the display apparatus 100 of the user using state information and surrounding environment information of the display apparatus 100 acquired during a predetermined time. As described above, state information of the display apparatus 100 includes information regarding a content displayed on the display apparatus 100 and information regarding a setting of the display apparatus 100, and thus, it is obvious that the controller 120 may determine various usage history information and preference information regarding the user's use of the display apparatus 100 using state information and surrounding environment information of the display apparatus 100 acquired during a predetermined time. Afterward, the controller 120 may store a user's history information and preference information determined through information acquired during a predetermined time, in the storage 140 as profile information of a registered user.

Accordingly, even if the identified user is not a preregistered user, when the user is identified, the user's profile information is stored in the storage 140, and the user then becomes a registered user, and thus, the controller 120 may determine a control command corresponding to a user's intent using the currently acquired information based on the stored user profile information.

If it is determined that an identified user is a preregistered user, profile information of the identified user exists in the storage 140, and thus, the controller 120 may analyze information acquired based on profile information of the identified user and determine a control command corresponding to the user's intent.

According to an exemplary embodiment, if it is determined that the identified user is a preregistered user, the controller 120 may determine usage history information and preference information using information acquired during a predetermined period, update user profile information of the identified user already stored in the storage 140 using determined usage history information and preference information, and then analyze currently acquired information based on updated user profile information and determine a control command corresponding to the user's instruction.

As described above, if a control command of the display apparatus 100 is determined, the controller 120 may change at least one of a content and a setting of the display apparatus 100 based on the determined control command. Herein, a setting of the display apparatus which is changed by the controller 120 may be the setting of the screen and the sound of the display apparatus 100 as described above. A specific description regarding this will be explained below.

According to an exemplary embodiment, the display apparatus 100 may further include an input device (not illustrated) where a user's instruction is inputted. Specifically, the input device (not illustrated) may input a user's instruction to change a setting and a content of the display apparatus 100. For this, the input device (not illustrated) may be realized as various forms such as a touch screen, a remote controller, a keyboard, a soft keyboard, a pointer, a mouse, a button and the like.

The controller 120 may control the display 130 to display a recommendation message which recommends changing at least one of a content and a setting of the display apparatus 100 if a control command is determined. Accordingly, if a user's instruction to change at least one of a content and a setting of the display apparatus 100 is inputted through the input device (not illustrated), the controller 120 may change at least one of a content and a setting of the display apparatus according to a control command.

The controller 120 may store an indication of whether a user has inputted an instruction to change at least one of a content and a setting of the display apparatus according to a recommendation message, that is, a response of the user regarding the displayed recommendation message, as response information of the user, in the storage 140. Afterward, the controller 120 may use the response information of the user stored in the storage unit when a control command corresponding to the user's intent is determined.

Specifically, if a user inputs a change instruction according to a recommendation message, the controller 120 may increase a weighted value regarding a determined control command, and if the user does not input a change instruction according to the recommendation message, the controller 120 may decrease a weighted value regarding a determined control command. Accordingly, even if user profile information and currently acquired information are identical, the controller 120 may determine another control command as a control command corresponding to a user's intent.

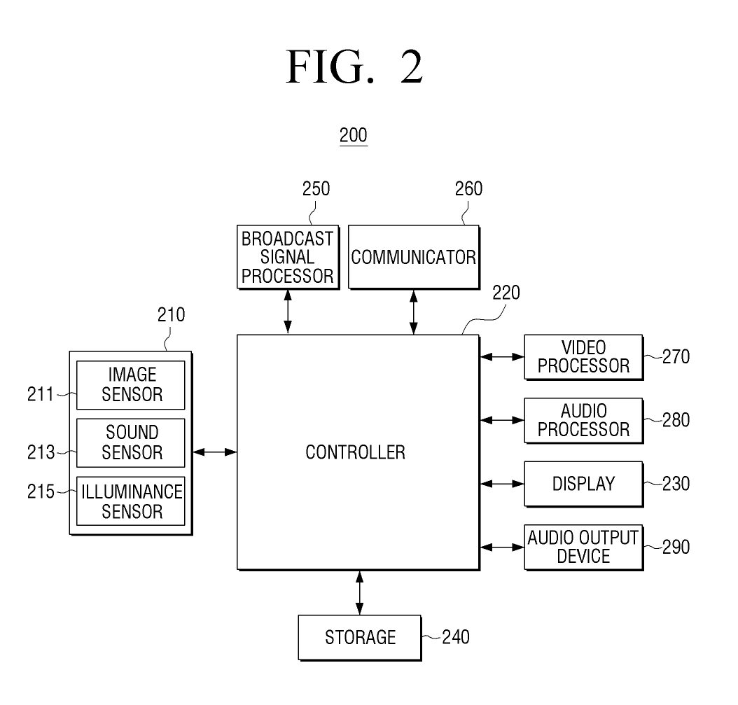

FIG. 2 is a block diagram illustrating a detailed configuration of a display apparatus according to an exemplary embodiment. With respect to a description of FIG. 2, descriptions regarding a configuration of the display apparatus and an operation of the configuration explained above are omitted. According to FIG. 2, the display apparatus 200 may include a detector 210, a controller 220, a display 230, a storage 240, a broadcast signal processor 250, a communicator 260, a video processor 270, an audio processor 280, and an audio output device 290.

As illustrated in FIG. 2, the detector 210 may include an image sensor 211, a sound sensor 213, and an illuminance sensor 215 to detect feature information of a user in the vicinity of the display apparatus 200 and surrounding environment information.

The image sensor 211 may acquire an image in the vicinity of the display apparatus 200. Specifically, the image sensor 211 may acquire an image of a user, including a face of the user, a position of the user and the like of a user in the vicinity of the display apparatus 200. For this, the image sensor may include a charge-coupled device (CCD) or a Complementary Metal-Oxide Semiconductor and the like, but is not limited thereto. The sound sensor 213 may acquire a sound in the vicinity of the display apparatus 200. Specifically, the sound sensor 213 may acquire a voice of a user in the vicinity of the display apparatus and a noise in the vicinity of the display apparatus 200. For this, the sound sensor 213 may include a microphone, but is not limited thereto. The illuminance sensor 215 may detect an illuminance in the vicinity of the display apparatus 200. For this, the illuminance sensor 215 may include cadmium sulfide (CdS) sensor, but is not limited thereto.

The detector 210 may acquire feature information of a user such as the user's face, a position of the user, a voice tone of the user, a level of loudness of the voice of the user and the like using an image of the user acquired by the image sensor 211 and a voice of the user acquired by the sound sensor 213. Also, the detector 210 may acquire information regarding noises in the vicinity of the display apparatus 200 such as a level of loudness of a noise according to a frequency band using a surrounding noise acquired through the sound sensor 213, and acquire information regarding an illuminance in the vicinity of the display apparatus 200 through the illuminance sensor 215.

Feature information of a user and surrounding environment information may be acquired by the detector 210 using information acquired through the image sensor 211, the sound sensor 213, and the illuminance sensor 215 as described above, and also may be acquired using information acquired through the sensors 211, 213, 215 by the controller 220 according to an exemplary embodiment.

The broadcast signal processor 250 is an element for receiving a broadcast signal, processing the received broadcast signal and converting the signal to audio data and other data. If a broadcast signal is received, the broadcast signal processor 250 may perform a signal process such as demodulating, equalizing, demultiplexing, decoding and the like regarding the signal, and generate video data and audio data. The generated video data is provided to the video processor 270 and the generated audio data is provided to the audio processor 280.

The communicator 260 may perform communications with various equipment external to the display apparatus 200. Specifically, the communicator 260 may communicate with an external server or an external terminal equipment which provides various contents through various wired networks and wireless networks. For this, the communicator 260 may include various communication cards and modules such as a wired local area network (LAN) card, a wireless LAN card, a Bluetooth module, a near field communication (NFC) module, a wireless communication module and the like. Herein, the wireless communication module represents a module which performs a communication according to communication standards such as Institute of Electrical and Electronics Engineers (IEEE), Zigbee, 3^{rd} generation (3G), 3^{rd} generation partnership project (3GPP), long term evolution (LTE) and the like.

The communicator 260 may communicate with an external optical disk playback apparatus. Specifically, the communicator 260 may transmit an instruction to control a playback apparatus which plays various optical disks such as a compact disk (CD), a digital video disc (DVD), a blu-ray disk and the like, and receive a content recorded in the optical disc from the optical disc playback apparatus by a control of the controller 220.

The communicator 260 may receive a remote control signal and transmit the signal to the input device (not illustrated). Specifically, if a user inputs a user manipulation through a remote controller to control the display apparatus 200, the remote controller may transmit a remote controller signal corresponding to a control manipulation and the communicator 260 may receive the remote control signal from the remote controller and convey the inputted signal to the input device (not illustrated). For this, the communicator 260 may include an infrared-ray communication module and may use a communication module such as a Bluetooth module according to a communication method with a remote controller.

The storage 240 is an element for storing various programs and data required for an operation of the display apparatus 200. Specifically, the storage 240 may store user profile information including usage history information regarding the display apparatus 200 and preference information of the user. Also, the storage 240 may store user feature information, surrounding environment information and state information of the display apparatus 200 acquired during a time which is predetermined for the controller 220 to determine user profile information. Also, the storage 240 may store various contents acquired from an external server through the communicator, and store metadata regarding a content such as EPG information acquired from an external server or additional data of a broadcast signal.

The video processor 270 is an element for processing video data. Specifically, the video processor 270 may process video data of a content provided from various sources such as the broadcast signal processor 250, the communicator 260 or the storage 240. For example, the video processor 270 may perform various image processes such as decoding, scaling, noise filtering, frame rate converting, resolution converting and the like regarding video data, and generate a video frame. The video frame generated as above may be displayed on the display 230.

The audio processor 280 is an element for processing audio data. Specifically, the audio processor 280 may process audio data of a content provided from various sources such as the broadcast signal processor 250, the communicator 260 or the storage 240. For example, the audio processor 280 may perform various processes such as decoding, amplifying, noise filtering, controlling of the level of loudness according to a frequency band and generate an audio signal. The audio signal generated as above may be converted and outputted to by the audio output device 290.

The display 230 displays an image of various contents. Specifically, the display 230 may display a video frame provided from the video processor 270. Specifically, the display 230 may display a message which recommends changing a content and a setting of the display apparatus 100, and display an image of a converted content by a control of the controller 220. For this, the display 230 may be realized as various forms of displays such as a liquid crystal display (LCD), organic light emitting diodes (OLED), a plasma display panel (PDP) and the like.

The audio output device 290 may output an audio signal provided from the audio processor 280. Specifically, the audio output device 290 may output a sound of a content converted by a control of the controller 220, and output an audio signal where a loudness is controlled according to a frequency band. For this, the audio output device 290 may include a speaker or an earphone insertion terminal and the like, but is not limited thereto.

The input device (not illustrated) may input various user manipulation instructions for controlling the display apparatus 200. Specifically, the input device (not illustrated) may input a manipulation instruction for changing a content and a setting of the display apparatus 100 inputted by a user according to a recommendation message which recommends changing at least one of a content and a setting of the display apparatus. Also, the inputter (not illustrated) may input a user manipulation instruction for changing a channel, and input a user manipulation instruction for changing a source which provides a content. Also, if a user inputs a user manipulation through a remote controller, a manipulation instruction may be inputted through a remote controller signal received through the communicator 260.

The controller 220 controls overall operations of the display apparatus 200. Hereinafter, a redundant explanation regarding the controller 120 based on FIG. 1 is omitted, and an operation of the controller 220 will be explained in detail through various exemplary embodiments.

As explained in FIG. 2, the controller 220 may determine a control command corresponding to an intent of a user, and change at least one of a content and a setting of the display apparatus 200 based on the determined control command. Herein, if the determined control command includes a change of a content, the controller 220 may control the communicator 260 to receive a content to be changed from an external server or an external terminal equipment.

According to an exemplary embodiment, the controller 220 may determine signal setting information corresponding to a content displayed on the display 210 using profile information of a user identified while the content is displayed, compare determined preference setting information and acquired setting information of the display apparatus 200, and change a setting of the display apparatus 200.

Specifically, the controller 220 may identify a user using feature information of the user acquired through the detector 210, and acquire user profile information of the identified user from the storage 240. Herein, the acquired profile information of the user may include preference setting information regarding a setting of the display apparatus 200 corresponding to at least one among a content, a content genre and a content type.

As described above, the controller 220 may acquire state information of the display apparatus 200, and the state information of the display apparatus 200 may include information regarding a content such as a title, a genre and a type of a displayed content and information regarding a setting of the display apparatus 200 such as an image setting and a sound setting.

Accordingly, the controller 220 may determine preference setting information corresponding to a currently displayed content using information regarding the content currently displayed on the display 230, and acquired preference setting information, compare determined preference setting information and setting information of the current display apparatus 200, and change a setting of the display apparatus 200.

For example, if a movie of a genre “A” is displayed on the display 230, the controller 220 may identify a user watching the movie, and acquire preference setting information of the identified user. As a result of a confirmation of acquired preference setting information of the user, if it is confirmed that the identified user darkens a brightness setting of the display apparatus 200 while the user watches the movies of genre “A”, and it is confirmed that the brightness level of the display apparatus 200 is currently set to a high brightness level, the controller 220 may change the setting of the brightness of the display apparatus to be dark. Herein, the controller 220 may display a message which recommends changing of the brightness setting, and if the user inputs a user instruction for changing the brightness setting to be dark on the recommendation message, the brightness setting may be changed to be dark.

According to another exemplary embodiment, the controller 220 may determine preference content information corresponding to surrounding environment information using profile information of a user identified while a content is displayed, compare determined preference content information and information regarding a content displayed currently, and change the content.

Specifically, the controller 220 may identify a user using feature information of a user acquired through the detector 210, and acquire user profile information of the identified user from the storage 240. Herein, profile information of the acquired user may include preference content information corresponding to surrounding environment information. Also, the controller 220 may acquire surrounding environment information through the detector 210, and thus, preference content information corresponding to the currently acquired surrounding information may be determined using acquired user profile information.

The controller 220 may acquire information regarding a displayed content, and thus, preference content information which is determined using information regarding a displayed content and user profile information may be compared. If information regarding a displayed content and user profile information are different from each other, a currently displayed content may be changed to a content according to the preference content information.

For example, if user profile information confirms that an identified user prefers to watch a content of the genre “horror” when the surrounding illuminance is low and at night, and surrounding environment information confirms that the current surrounding illuminance acquired through the illuminance sensor 215 is below a predetermined brightness and a current time is 2 o'clock in the morning, the controller 220 may determine whether a content displayed on the display 230 is a content of the genre “horror”, and if the genre of the content is not honor, the content may be changed to a content of the genre “horror”, and the content of the genre “horror” may be displayed.

According to another exemplary embodiment, profile information of a user may include information regarding a content corresponding to surrounding environment information and information regarding user's age group and gender. In this case, the controller 220 may determine information regarding the age group and gender of the user using the user's feature information. A method of determining information regarding the user's age group and gender using the user's feature information may be a well-known technology, but it is not related to the exemplary embodiments so that an explanation thereof is omitted. Accordingly, if it is determined that an identified user is in his/her thirties, surrounding illuminance is low and it is currently night, a content of the genre “honor” may be recommended.

According to another exemplary embodiment, the controller 220 may determine whether a user zaps a channel using profile information of the user identified while a content is displayed, and if it is determined that the user is watching a specific channel after channel zapping, a preference regarding the specific channel is increased and it is stored as the profile information of the user.

Specifically, the controller 220 may acquire state information of the display apparatus 200 and the state information of the display apparatus 200 includes information regarding a channel selected by the user, and thus, the controller 220 may know information regarding a channel change of the user. Specifically, a channel zapping represents avoiding a channel so that an advertisement and the like is not viewed, and thus, the controller 220 may determine that a channel zapping instruction exists if a channel is changed during a predetermined time, and store this as usage history information of the user.

Accordingly, the controller 200 may determine whether a user zaps a channel using usage history information of the identified user, and determine whether the user watches a specific channel after a channel zapping through state information of the current display apparatus 200. Accordingly, if it is determined that the user watches a specific channel after a channel zapping, the controller 220 may increase the user's preference regarding the corresponding specific channel and store profile information of the user in the storage 240.

If a channel is recommended to the user afterward, the controller 220 may recommend a channel with a high weight value regarding the corresponding specific channel.

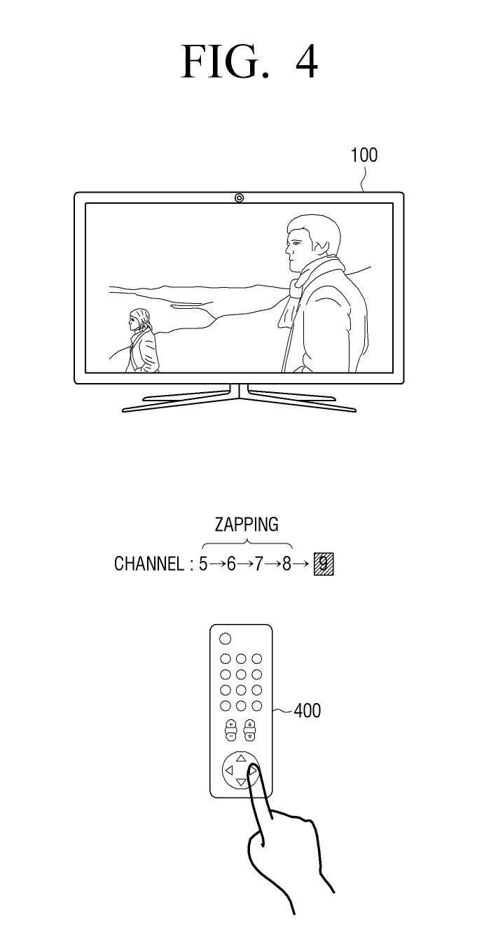

FIG. 4 is an example of a user watching a specific channel after a channel zapping. In FIG. 4, the user is currently watching channel 9 after zapping channel 5, channel 6, channel 7 and channel 8. In this case, the controller 220 may increase a preference of the user regarding channel 9 and store the information as profile information of the user. It is possible that the controller 220 decreases a preference of the user regarding channel 5, channel 6, channel 7 and channel 8 relatively, and stores the information regarding the increased preference of channel 9 and the decreased preference for channels 5, 6, 7, and 8 as profile information of the user.

According to another exemplary embodiment, if a noise in the vicinity of the display apparatus 200 is acquired through the sound sensor 213 while a content is displayed on the display 230, the detector 210 may analyze the acquired noise information and acquire information regarding the loudness of the acquired noise according to a frequency band. Herein, a well-known method of determining the loudness of a noise according to frequency band may be used. This method of determining the loudness of noises is not related to the essence of the exemplary embodiments, accordingly a detailed explanation is omitted. If the loudness of a noise of a specific frequency band is greater than a predetermined value, the controller 120 may increase and output the loudness of the volume of the display apparatus at the specific frequency band among settings of the sound of the display apparatus.

If a noise in the vicinity of the sound sensor 213 is acquired through the sound sensor 210, the controller 220 may analyze the acquired noise and obtain information regarding the loudness of the noise according to a frequency band.

According to another exemplary embodiment, if a plurality of users is recognized through the detector 210, the controller 220 may identify each user based on feature information of each user, combine profile information of identified users and determine a control command corresponding to a common intent of each of the plurality of users.

Specifically, if an image and a voice of a plurality of users are acquired through the image sensor 211 and the sound sensor 213, the detector 210 may determine user feature information of each of the plurality of users. Accordingly, the controller 220 may identify each user based on user feature information regarding each of the plurality of users, combine profile information of identified users and determine a control command corresponding to an intent of each of the plurality of users.

For example, if 4 users, A, B, C, and D are recognized, the controller 220 may combine preference information of each user, determine a common preference content and display a message which recommends watching the determined common preference content.

According to another exemplary embodiment, if a user is identified, the controller 220 may determine at least one between a preference application and a preference content of the user using profile information of the identified user, and pre-load at least one between the determined preference application and the determined preference content.

Specifically, profile information of the user includes usage history information of the display apparatus 200 of the user, and thus, the controller 220 may store information regarding an application that the user frequently uses, and a channel and a genre of a content that the user watches frequently as frequency information in the storage 240 using the user's usage history information.

Accordingly, if the identified user frequently uses a specific application as a result of the confirmation of the user profile information, the controller 220 may pre-load the corresponding preference content and provide a quick execution when the user wants to execute the corresponding specific application.

For example, if there is a content preferred by a user as a result of a confirmation of the user profile information and the corresponding preferred content exists in an external server, the controller 220 may access a corresponding server beforehand and download the corresponding preferred content, and a playback may be provided quickly when the user wants to watch the corresponding preference content.

According to another exemplary embodiment, if it is determined that a currently displayed content ends at a predetermined time or period from a current time, the controller 220 may determine preference content information of a user using profile information of the identified user, and recommend a content based on the predetermined preference content information.

Specifically, the controller may acquire information regarding a current time and a currently displayed content, and determine a remaining time until the displaying of the currently displayed content ends. The controller 220 may determine information regarding a preference content of an identified user using user profile information, and thus, if the currently displayed content is scheduled to end in a predetermined time, the controller 220 may recommend a content that the user prefers.

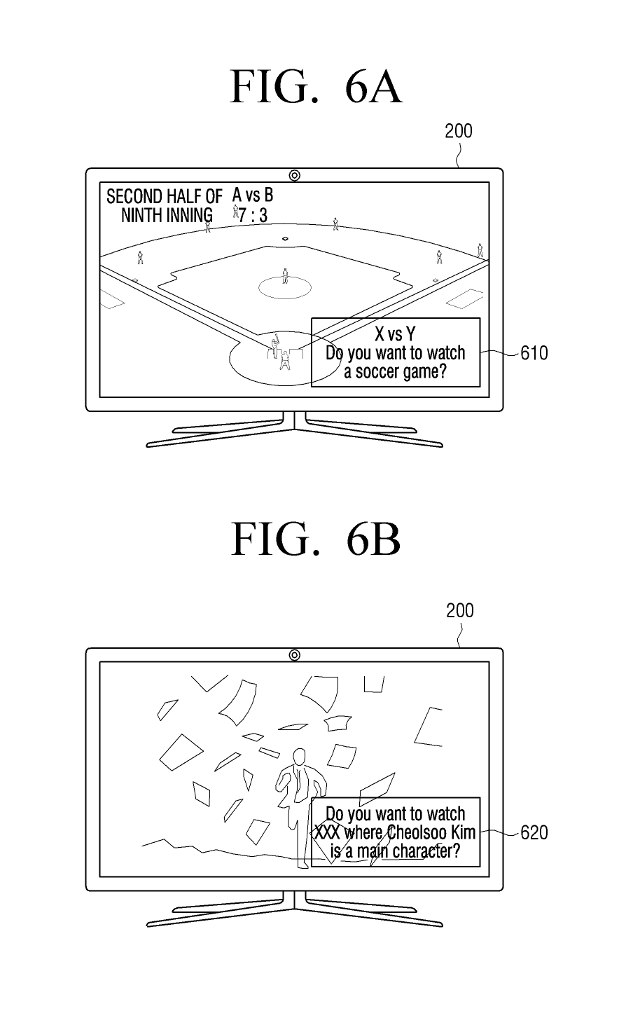

FIG. 6A illustrates an example of the display apparatus 200 displaying a message which recommends a content to a user. As illustrated in FIG. 6(A), a baseball game in the second half of the ninth inning is displayed in a current display 230, and thus, it is known that the game will end soon. In this case, the controller may confirm preference content information that the user prefers a soccer game based on profile information of the identified user and display a message 610 which recommends watching a soccer game where team X and team Y compete.

According to another exemplary embodiment, the controller 220 may determine information regarding a preferred or favorite character or entertainer of the user based on profile information of the identified user and recommend a content which includes the determined preferred character or entertainer.

Specifically, the controller 220 may know information regarding a content that the user previously watched by referring to the usage history information of the identified user. Accordingly, the controller 220 may determine information regarding a character or an entertainer that the user prefers to watch based on information regarding a content that the user usually watches. Accordingly, the controller 220 may display a message which recommends a content which includes a character or entertainer that the identified user prefers.

For example, as a result of analyzing the user's usage history, if the user usually watches a content where a person named “Cheolsoo Kim” appears, the controller 220 may determine that ‘Cheolsoo Kim” is a person that the user prefers to watch. Accordingly, as illustrated in FIG. 6B, the controller 220 may display a message 620 which recommends watching a content named XXX where “Cheolsoo Kim” appears as a main character.

According to another exemplary embodiment, if it is determined that a user is not watching a currently displayed content, the controller 220 may decrease a brightness of the display 230. Specifically, if an image of the user is not acquired through the image sensor 211 while the content is being displayed, the controller 220 may determine that the user is not watching the content. Accordingly, the controller 220 may decrease a brightness of the display 230 by controlling a dimming of a backlight unit and the like, and reduce the power consumption.

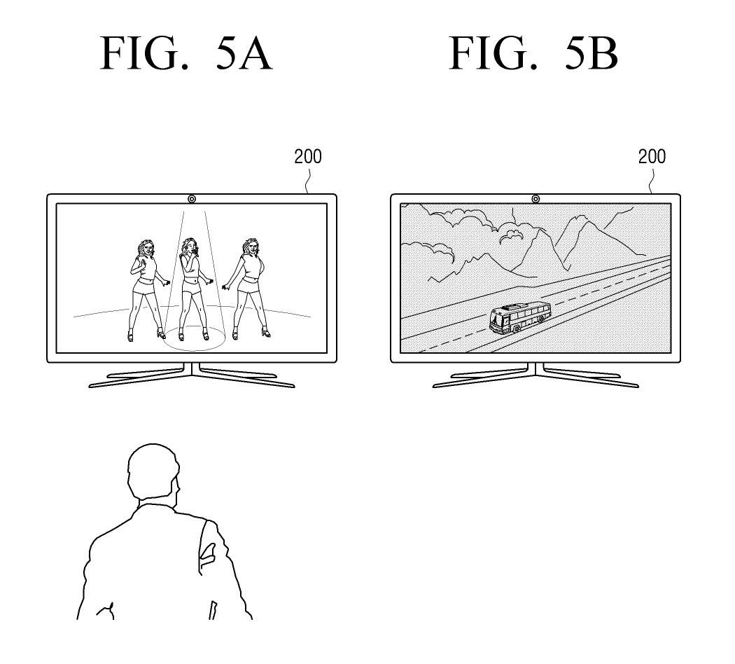

FIGS. 5A and 5B illustrate the above-described feature. Specifically, FIG. 5A illustrates a case where a user watches a content currently being displayed on the display apparatus 200, and FIG. 5B illustrates a case where the user is not watching a content currently being displayed on the display apparatus 200. In other words, in FIG. 5B, a brightness of the display 230 is decreased.

According to an exemplary embodiment, the detector 210 may determine how much interest the user is showing with regard to the displayed content. Specifically, the detector 210 may analyze the user's face, position and the like using an image of the user acquired by the image sensor 211, and determine the level of interest of the user regarding the content being displayed on the display apparatus 200.

For example, it may be determined whether the eyes of the user's face is directed toward the display apparatus 200, and if a time where the gaze of the user's eyes are directed to the display apparatus 200 is equal to or greater than a predetermined period, it may be determined that the interest level of the user is high. However, this is only one example of determining the interest level of the user, and other methods of determining the interest level may be used. Also, according to an exemplary embodiment, instead of the detector 210 being used to determine the interest level of the user, the controller 220 may determine the interest level.

Accordingly, the controller 220 may determine a time of determining a control command corresponding to the intent of a user based on the interest level of the user. For example, if the interest level of the user is not more than a predetermined value, the controller may determine a control command corresponding to the intent of the user and display a message which recommends changing of a content or a setting of the display apparatus 200.

The above-described example is a case where the storage 240 is included in the display apparatus 200. However, the storage 240 may be a separate database external to the display apparatus 200.

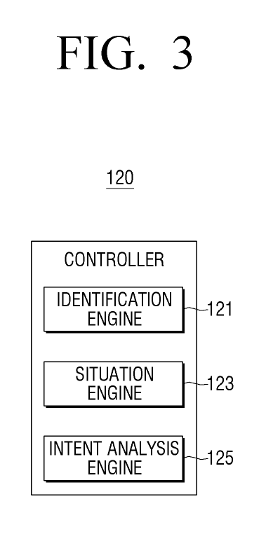

FIG. 3 is a block diagram illustrating a configuration of the controller 120 of the display apparatus 100 according to another exemplary embodiment. Referring to FIG. 3, the controller 120 includes an identification engine 121, a situation engine 123, and an intent analysis engine 125.

The identification engine 121 may identify a user based on information regarding the user's face, a position of the user, the interest level of the user, a voice tone, a loudness level of the voice and the like acquired through the detector 110, determine the user's gender and age, and register the user. Also, an action that the user is currently performing may be determined.

The situation engine 123 may collect information regarding a current time, a surrounding illumination, surrounding noises, information regarding a displayed content, information regarding an executed application, information regarding a setting of a screen and sound of the display apparatus 100, and the like, and determine a situation of the user and the display apparatus 100.

The intent analysis engine 125 may determine a control command corresponding to the intent of a user that the user does not request explicitly based on user profile information which includes information provided from the situation engine 123 and usage history information and preference information of the user stored in the storage 140.

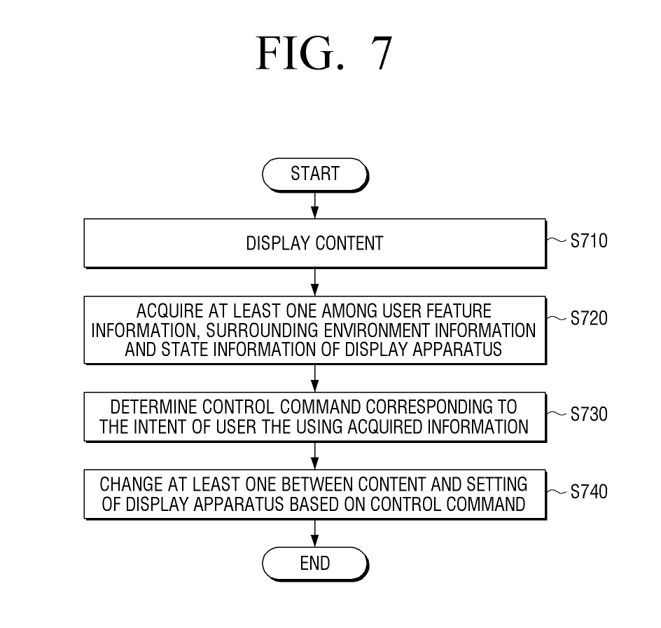

FIG. 7 is a flowchart illustrating a method of controlling the display apparatus 100 according to an exemplary embodiment. In FIG. 7, the display apparatus 100 displays a content (operation S710). Afterward, the display apparatus 100 acquires at least one among user feature information, surrounding environment information and state information of the display apparatus 100 (operation S720), and determines a control command corresponding to the intent of the user using at least one among the user feature information, the surrounding environment information and the state information of the display apparatus 100 (operation S730).

Herein, the display apparatus 100 may further include the storage 140 which stores user profile information including usage history information and preference information of the user, identify a user based on the acquired feature information of the user, analyze at least one among acquired user feature information, surrounding information and state information of the display apparatus 100, based on the profile information of the identified user, and determine a control command corresponding to the intent of the user.

Afterward, the display apparatus 100 changes at least one between a content and a setting of the display apparatus 100 according to a determined control command.

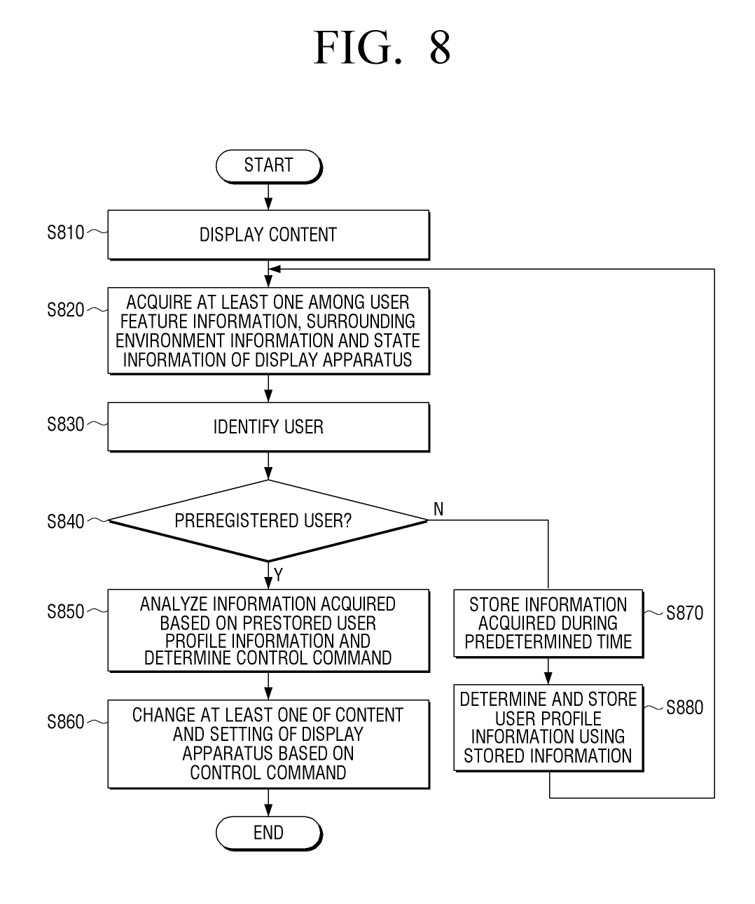

FIG. 8 is a flowchart illustrating a method of controlling the display apparatus according to a still another exemplary embodiment. In FIG. 8, the display apparatus 100 displays a content (operation S810), and acquires at least one among feature information of the user, surrounding environment information and state information of the display apparatus 100 (operation S820). Afterward, the display apparatus 100 identifies the user based on feature information of the acquired user (operation S830), and determines whether the identified user is a preregistered user (operation S840).

If it is determined that the identified user is not a preregistered user (S840, N), the display apparatus 100 may store at least one among feature information of a user acquired during a predetermined time, surrounding environment information and state information of the display apparatus 100 in the storage unit 140 (operation S870). Also, the display apparatus 100 may analyze information stored in the storage 140, determine user profile information including usage history information and preference information of the user, and store the determined user profile information (operation S880).

If it is determined that the identified user is a preregistered user (operation S840, Y), the display apparatus 100 may analyze at least one among acquired user feature information, surrounding environment information, and state information of the display apparatus based on user profile information corresponding to an identified user among pre-stored user profile information, determine a control command corresponding to an intent of the user (operation S850), and change at least one between a content and a setting of the display apparatus 100 based on the determined control command (operation S860).

As above, according to various exemplary embodiments, even if a user's intent is not expressed explicitly through an input method, the user of the display apparatus may be provided various services corresponding to the intent of the user. Specifically, if the user does not log in separately, various services corresponding to the intent of the user may be provided.

An operation of a controller of the display apparatus and method of controlling the display apparatus according to various exemplary embodiments are generated as software and stored in the non-transitory readable medium. Also, the non-transitory readable medium may be equipped with a display apparatus.

For example, a program code for performing a method of controlling the display apparatus including displaying a content, acquiring at least one among feature information of a user around the display apparatus, surrounding environment information, and state information of the display apparatus, determining a control command corresponding to an intent of the user using the acquired information, and changing at least one between a content and a setting of the display apparatus based on a control command, may be provided.

The non-transitory readable medium means a medium which stores a data semi-permanently and is readable by an apparatus, not a media which stores a data for a short period such as a register, a cache, a memory and so on. Specifically, a CD, a DVD, a hard disk, a blu-ray disk, a USB, a memory card and ROM may be the non-transitory readable medium.

Exemplary embodiments were illustrated and explained above, but the application is not limited to the described exemplary embodiments. Also, the description of the exemplary embodiments is intended to be illustrative, and not to limit the scope of the claims, and it would be appreciated by those skilled in the art that changes may be made to the exemplary embodiments without departing from the principles and spirit of the application, the scope of which is defined in the appended claims.

What is claimed is:

1. A display apparatus, comprising:
a display configured to display a content;
a detector configured to acquire feature information of a user in the vicinity of the display apparatus and surrounding environment information; and
a controller configured to acquire state information of the display apparatus, determine a control command corresponding to an intent of the user based on at least one of the acquired feature information of the user, the acquired surrounding environment information and the acquired state information of the display apparatus, and change at least one of the content and a setting of the display apparatus based on the control command.

2. The display apparatus as claimed in claim 1, further comprising:
a storage configured to store user profile information including the user's usage history information and preference information of the user;
wherein the controller identifies the user based on the feature information of the user, analyzes at least one of the feature information of the user, the surrounding environment information and the state information of the display apparatus based on profile information of the identified user, and determines the control command corresponding to the intent of the user.

3. The display apparatus as claimed in claim 2, wherein the controller, in response to the identified user not being a pre-registered user, registers the identified user, determines the user's usage history information and preference information based on at least one of the user's feature information, the surrounding environment information and state information of the display apparatus acquired during a predetermined time, and stores the determined usage history information as profile information of the registered user.

4. The display apparatus as claimed in claim 2, wherein the state information of the display apparatus comprises setting information of the display apparatus, and
wherein the controller determines preference setting information corresponding to the displayed content based on the profile information of the identified user while the content is displayed, compares the setting information of the display apparatus and the preference setting information, and changes the setting of the display apparatus based on a result of the comparing.

5. The display apparatus as claimed in claim 2, wherein the state information of the display apparatus comprises information regarding the displayed content, and
wherein the controller determines preference content information corresponding to the acquired surrounding environment information based on the profile information of the identified user while the content is displayed, compares information regarding the displayed content and the preference content information and changes the content based on a result of the comparing.

6. The display apparatus as claimed in claim 2, wherein the controller determines whether a channel is zapped by the user based on profile information of the identified user while the content is displayed, and if it is determined that the user is watching a specific channel after the channel zapping operation, increases a preference of the user with regard to the specific channel and adds the increased preference of the specific channel to the profile information of the user.

7. The display apparatus as claimed in claim 2, wherein the surrounding environment information comprises information regarding noises in the vicinity of the display apparatus, and
wherein the controller in response to a loudness of a noise of a specific frequency band among the surrounding noises acquired through the detector while the content is displayed being greater than a predetermined value, increases and outputs a loudness of a volume of the display apparatus at the specific frequency band.

8. The display apparatus as claimed in claim 2, wherein the controller in response to a plurality of users being recognized through the detector, identifies each of the plurality of users based on specific information of each of the plurality of users, combines profile information of each of the plurality of users, and determines a control command based on a common intent of each of the plurality of users.

9. The display apparatus as claimed in claim 2, wherein the controller in response to the user being identified, determines information regarding at least one of a preference application and a preference content of the user based on profile information of the identified user, and pre-loads at least one of the determined preference application and the determined preference content.

10. The display apparatus as claimed in claim 2, wherein the controller, if it is determined that a viewing of the displayed content will end within a predetermined period from a current time, determines preference content information of the user based on the profile information of the identified user, and recommends the content based on the determined preference content information.

11. The display apparatus as claimed in claim 2, wherein the controller determines information regarding a preferred character of the identified user based on profile information of the identified user, and recommends a content which includes the determined preferred character.

12. The display apparatus as claimed in claim 2, wherein the controller, if it is determined that the user is not watching the displayed content, decreases a luminance of the display.

13. A method of controlling a display apparatus, the method comprising:
displaying a content;
acquiring at least one of feature information of a user in the vicinity of the display apparatus, surrounding environment information, and state information of the display apparatus;
determining a control command corresponding to an intent of the user based on the acquired information; and
changing at least one of the content and a setting of the display apparatus based on the control command.

14. The method as claimed in claim 13, wherein the display apparatus comprises a storage configured to store user profile information including the user's usage history information and preference information,
wherein determining the control command comprises:
identifying the user based on specific information of the user; and
analyzing at least one of the feature information of the user, the surrounding environment information, and the state information of the display apparatus based on the profile information of the identified user and determining a control command corresponding to the intent of the user.

15. The method as claimed in claim 14, further comprising:
determining whether the identified user is a pre-registered user;
in response to the identified user not being a pre-registered user as a result of the determination, registering the identified user;
determining the registered user's usage history information and preference information based on at least one of feature information of the user acquired during a predetermined time, the surrounding environment information, and the state information of the display apparatus; and
storing the determined usage history information and the preference information as profile information of the registered user.

16. A method of controlling a display apparatus, the method comprising:
displaying a content;
acquiring at least one of user feature information, surrounding environment information and state information of the display apparatus;
identifying a user based on the user feature information, and determining whether the identified user is a preregistered user;
obtaining user profile information of the identified user in response to a determination that the identified user is the preregistered user,
determining a control command corresponding to an intent of the identified user, and based on the obtained user profile information of the identified user, and
changing at least one of the content and a setting of the display apparatus based on the determined control command.

17. The method of claim 16, wherein the state information comprises at least one of information regarding the content, and information regarding a setting of the display apparatus.

18. The method of claim 16, wherein the user profile information comprises preference setting information corresponding to at least one of a content, a content genre, and a content type.

19. The method of claim 16, wherein the surrounding environment information comprises information regarding at least one of an illuminance in the vicinity of the display, noises in the vicinity of the display, and a current time.

20. The method of claim 16, wherein when a plurality of user are identified by the display apparatus, the control command is determined based on a combined intent of each of the plurality of users.
